(19) United States
(12) Patent Application Publication
(10) Pub. No.: US 2015/0264565 A1
(43) Pub. Date: Sep. 17, 2015

(54) MACHINE BIOMETRICS BY THE USE OF DYNAMIC BENCHMARKS

(71) Applicant: Yahoo! Inc., Sunnyvale, CA (US)

(72) Inventors: Benoit Schillings, Los Altos Hills, CA (US); Daryl Low, San Jose, CA (US)

(73) Assignee: Yahoo! Inc., Sunnyvale, CA (US)

(21) Appl. No.: 14/204,692

(22) Filed: Mar. 11, 2014

(51) Int. Cl. H04W 12/06; H04M 1/725

(52) U.S. Cl. CPC H04W 12/06; H04M 1/72577

(57) ABSTRACT

In one embodiment, a request may be transmitted to a mobile device, where the request identifies one or more actions. An indication of a first time value may be received from the mobile device, where the first time value indicates a time that it has taken for the mobile device to perform the one or more actions. A device type of the mobile device may be determined. At least a second time value associated with the device type may be obtained, where the second time value indicates an approximate time that it takes for devices of the device type to perform the one or more actions. The first time value may be compared with the second time value. The mobile device may be authenticated according to a result of the comparing.

### BACKGROUND

The disclosed embodiments relate generally to methods and apparatus for authenticating mobile devices.

Many networks implement a mobile infrastructure that supports access to the network via mobile devices. While most networks implement network security, traditional network security does not provide adequate protection against attacks on the mobile infrastructure. Unfortunately, such attacks are becoming increasingly sophisticated, making it harder to detect and repel intrusions.

### SUMMARY

The disclosed embodiments enable mobile devices to be authenticated. This may be accomplished based, at least in part, upon a time that it takes for the mobile devices to perform various actions.

In accordance with one embodiment, a request may be transmitted to a mobile device, where the request identifies one or more actions. An indication of a first time value may be received from the mobile device, where the first time value indicates a time that it has taken for the mobile device to perform the one or more actions. A device type of the mobile device may be determined. At least a second time value associated with the device type may be obtained, where the second time value indicates an approximate time that it takes for devices of the device type to perform the one or more actions. The first time value may be compared with the second time value. The mobile device may be authenticated according to a result of the comparing.

In accordance with another embodiment, a mobile device may receive a request from a device, where the request identifies one or more actions. The mobile device may perform the one or more actions. The mobile device may ascertain a time that it has taken the mobile device to perform the one or more actions. The mobile device may transmit an indication of the time it has taken to perform the one or more actions to the device. In addition, the mobile device may transmit an indication of a device type of the mobile device to the device.

Various embodiments may be implemented via a device comprising a processor and a memory. The processor and memory are configured to perform one or more of the above described method operations. Other embodiments may be implemented via a computer readable storage medium having computer program instructions stored thereon that are arranged to perform one or more of the above described method operations.

These and other features and advantages of the disclosed embodiments will be presented in more detail in the following specification and the accompanying figures which illustrate by way of example the principles of the disclosed embodiments.

### BRIEF DESCRIPTION OF THE DRAWINGS

FIG. 1 is a diagram illustrating an example system in which various embodiments may be implemented.

FIG. 2 is a process flow diagram illustrating an example method of authenticating a mobile device by a mobile infrastructure of a network according to various embodiments.

FIG. 3 is a process flow diagram illustrating an example method of communicating by a mobile device with a mobile infrastructure of a network to support authentication of the mobile device in accordance with various embodiments.

FIG. 4 is a schematic diagram illustrating another example embodiment of a network in which various embodiments may be implemented.

FIG. 5 is a schematic diagram illustrating an example client device in which various embodiments may be implemented.

FIG. 6 is a schematic diagram illustrating an example computer system in which various embodiments may be implemented.

### DETAILED DESCRIPTION OF THE SPECIFIC EMBODIMENTS

Reference will now be made in detail to specific embodiments of the disclosure. Examples of these embodiments are illustrated in the accompanying drawings. While the disclosure will be described in conjunction with these specific embodiments, it will be understood that it is not intended to limit the disclosure to these embodiments. On the contrary, it is intended to cover alternatives, modifications, and equivalents as may be included within the spirit and scope of the disclosure as defined by the appended claims. In the following description, numerous specific details are set forth in order to provide a thorough understanding of the disclosure. The disclosed embodiments may be practiced without some or all of these specific details. In other instances, well known process operations have not been described in detail in order not to unnecessarily obscure the disclosure. The Detailed Description is not intended as an extensive or detailed discussion of known concepts, and as such, details that are known generally to those of ordinary skill in the relevant art may have been omitted or may be handled in summary fashion.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Many attacks against mobile infrastructures are performed by computers that pretend to be a mobile device and perform extensive login or access attempts. Unfortunately, differentiating an actual mobile device from a computer impersonating a mobile device is particularly difficult, since in many cases computers can emulate responses an actual mobile device would provide.

Mobile devices can be of various device types, which may each be defined by information such as a category, brand (e.g., manufacturer), and/or model. Example categories of mobile devices include, but are not limited to, cellular telephones, smart phones, display pagers, radio frequency (RF) devices, infrared (IR) devices, Personal Digital Assistants (PDA), handheld computers, tablet computers, laptop computers, set top boxes, and wearable computers. Generally, a mobile device within a given category of mobile device may be available from one of a plurality of brands. Moreover, each brand may offer one or more models of mobile devices for the particular category of mobile device.

Generally, every type of mobile device will have a unique hardware architecture. As a result, the properties of the hardware of each device type will also differ. For example, each device type will have a particular central processing unit (CPU), CPU speed, cache size, graphics processing unit (GPU), GPU speed, bus speed, bus size, memory organization, flash memory bandwidth, etc. Therefore, the time it takes for a mobile device to perform various tasks will vary according to the hardware architecture and corresponding capabilities of its corresponding device type (e.g., category, brand, and/or model).

In accordance with various embodiments, an equivalent of a “biometric” profile may be created for each device type. The biometric profile may store or otherwise indicate one or more values or value ranges, where each value or value range indicates an approximate time that it generally takes for a mobile device of the corresponding device type to complete a particular performance benchmark. To authenticate a mobile device of a particular device type, the mobile device may execute one or more performance benchmarks, resulting in one or more completion times. By comparing the completion times with the permissible values for the performance benchmarks for the particular device type, it is possible for a mobile infrastructure to authenticate the mobile device.

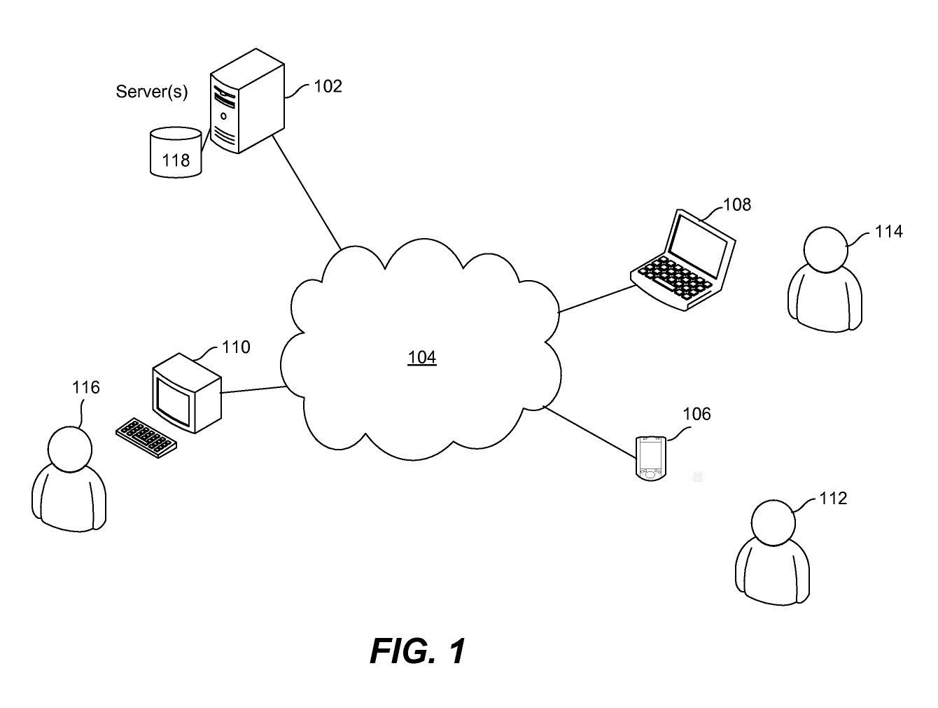

Various embodiments may be implemented, at least in part, by a mobile device and/or a remotely located server that is located in a remote location with respect to the mobile device. An example system in which various embodiments may be implemented is described in further detail below with reference to FIG. 1.

Example System

FIG. 1 is a diagram illustrating an example system in which various embodiments may be implemented. As shown in FIG. 1, the system may include one or more servers 102. In accordance with various embodiments, the servers 102 may be associated with a web site such as a social networking web site. Examples of social networking web sites include Yahoo, Facebook, Tumblr, LinkedIn, Flickr, and Meme. The server(s) 102 may enable the web site to provide a variety of services to its users. More particularly, users of the web site may perform activities such as access user accounts or public user profiles, interact with other members of the web site, access and transmit messages, upload files (e.g., photographs, videos), purchase goods or services, access information or content posted on the web site, etc.

In this example, the server(s) 102 may obtain or otherwise receive data (e.g., account data and/or user profile) and/or requests (e.g., requests to access the web site, search requests or account requests pertaining to a particular user account). Requests may include requests sent via the Internet 104 from one or more devices 106, 108, 110 in association with corresponding users 112, 114, 116, respectively. In this example, the devices 106, 108 are mobile devices. The server(s) 102 may personalize content to be provided to users, either automatically or in response to requests. In addition, the server(s) 102 may support a mobile infrastructure that is accessible by the mobile devices 106, 108. The mobile infrastructure may authenticate such mobile devices, as will be described in further detail below.

The server(s) 102 may have access to one or more data stores 118 that are coupled to the server(s) 102. Each of the data stores 118 may include one or more memories. The data stores 118 may store account information (e.g., data) for a plurality of user accounts and/or profiles, content, and/or information supporting authentication of mobile devices.

The server(s) 102 may authenticate mobile devices of users, who may be members or users of the web site. In the following description, examples will be described with reference to the mobile device 106 of the user 112. However, it is important to note that the disclosed embodiments may also be implemented with respect to multiple devices of a given user.

In accordance with various embodiments, the mobile device 106 may be configured with information indicating a device type of the mobile device 106. For example, the device type may include a category of mobile device, brand, and/or mobile of the mobile device.

The mobile device 106 may be configured to perform one or more actions, which may be referred to as performance benchmarks. More particularly, the mobile device 106 may be statically or dynamically configured such that it stores computer-readable instructions for performing each of the performance benchmarks. In some embodiments, the mobile device 106 may be configured to perform each of the performance benchmarks to complete an authentication process. In other embodiments, the mobile device 106 may be configured to perform a plurality of performance benchmarks, but may only perform a subset of the performance benchmarks to complete the authentication process at any given time.

Moreover, the mobile device 106 may be configured to determine a time that it takes for the mobile device 106 to complete a set of one or more performance benchmarks. This may be accomplished, for example, by setting a timer at the beginning of the performance of the set of performance benchmarks and stopping the timer at the end of the completion of the performance benchmarks. The mobile device 106 may send a message to the server(s) 102, where the message indicates the time that it has taken for the mobile device 106 to complete the set of performance benchmarks.

In some embodiments, the mobile device 106 may complete the set of benchmarks and determine the time it has taken for the mobile device 106 to complete the set of benchmarks dynamically during each authentication process. In other embodiments, the mobile device 106 may store a completion time indicating the time it has taken for the mobile device 106 complete the set of benchmarks, enabling the mobile device 106 to retrieve the completion time for transmission to the server(s) 102 at a later time during subsequent authentication processes.

The mobile device 106 may communicate the time it has taken for it to complete the set of benchmarks to the server(s) 102 automatically or in response to a query from the server(s) 102. In some embodiments, in response to a query from the server(s) 102, the mobile device 106 may perform the set of performance benchmarks, ascertain the time it has taken for the mobile device to complete the set of benchmarks, and transmit a message indicating the time to the server(s) 102. In other embodiments, the mobile device 106 may retrieve and transmit a previously stored completion time in response to such a query.

The set of performance benchmarks to be performed by the mobile device 106 may be identified in a query received from the server(s) 102. More particularly, the server(s) 102 may select one or more performance benchmarks from a plurality of performance benchmarks. For example, the server(s) 102 may execute a random function to select the set of performance benchmarks. In some implementations, the performance benchmarks may be selected independently from the device type of the mobile device 106. In other implementations, the performance benchmarks may be selected based, at least in part, upon the device type of the mobile device 106.

In addition, one or more of the set of the performance benchmarks may be performed according to one or more values identified in the query. More particularly, a performance benchmark may include an Application Programming Interface (API) that identifies one or more input parameters (i.e., variables). Upon receiving the values for these parameters, the performance benchmark may be executed. The values may be selected by the server(s) 102 according to various algorithms such as a random function or based, at least in part, upon the device type of the mobile device 106.

In accordance with various embodiments, the server(s) 102 may ascertain approximate completion time(s) that would generally be expected for mobile devices of the device type of the mobile device 106 (e.g., based upon historical data). More particularly, the server(s) 102 may retrieve information from a biometric profile pertaining to the device type of the mobile device 106 from the data store(s) 118. The data store(s) 118 may store a biometric profile for each one of a plurality of device types. The biometric profile may include one or more values or value ranges, where each value or value range indicates an approximate time that it generally takes for a mobile device of the corresponding device type to complete a particular performance benchmark. For example, the biometric profile may indicate that it typically takes mobile devices of a particular mobile device type approximately 3.1 milliseconds to complete a particular benchmark. In addition, the biometric profile may further indicate an acceptable error range. For example, the value or value range identified in the biometric profile may be correct within a range of 0.01 milliseconds.

The server(s) 102 may determine whether to authenticate the mobile device 106 based upon a comparison of the actual completion time against completion time(s) that are considered expected for the particular device type. In this manner, the server(s) 102 may ascertain whether the completion time is a realistic time for completion of the benchmarks by mobile devices of the device type.

Upon being successfully authenticated, the mobile device 106 may access, receive, or otherwise obtain content from the server(s) 102. More particularly, a user may selectively retrieve content from the server(s) 102. In addition, the user may receive content automatically. More particularly, the content that is received may be selected based, at least in part, upon a user profile associated with a user of the mobile device 106.

Data Stores and User Profiles

A user profile may be updated under various circumstances. As will be described in further detail below, an enormous amount of information may be collected via web sites based upon various interactions (or lack thereof) of individuals with the content provided via the web sites. For example, the web sites may ascertain whether the individuals access specific content, which may or may not have been recommended by the web sites. As another example, the web sites may record a number of clicks by individuals to various content items. In addition, the user profile may be updated based upon content or applications accessed via a mobile device (e.g., in response to messages or requests transmitted by the mobile device to the server(s)) 102.

The information that is obtained by the server(s) 102 may be stored to the data stores 118. More particularly, the information may be stored, maintained, and/or updated in the data stores 118 such that the information is associated with the corresponding user and/or device. The information may include that gathered or obtained by the server(s) 102 as well as that received from other device(s), which may include a mobile device. A description of the information that may be stored, maintained, and updated in the data stores 118 will be described in further detail below. The data stores 118 may store content or references to content, which may include content items, hypertext links via which content items may be accessed, and/or URLs via which content items may be accessed. The content may be indexed for efficient retrieval.

Content may include digital media items, which may include text, audio, video, photographs, and/or other images. For example, digital media items may be accessed via a corresponding Uniform Resource Locator (URL). The term content as used herein may refer to a collection of content or a specific content item, which may be one of a plurality of content items within a collection of content.

Content accessible via the Internet may be contained within an object, such as a Web object, web page, web site, electronic document, or the like. An item in a collection of content may be referred to as an “item of content” or a “content item,” and may be retrieved from a “Web of Objects” comprising objects made up of a variety of types of content. For example, a newspaper available via a particular web site may serve as a collection of content that includes a plurality of content items.

In addition, the data stores 118 may store information such as the characteristics of the content, which may be stored in association with the content. More particularly, the content may be a collection of content or a specific content item, which may be one of a plurality of content items within a collection of content. For example, the characteristics of the content may indicate information such as an identifier of a content item (e.g., a pointer to a digital version of a content item or title of the content item), a primary subject or topic of the content item, one or more key words, results of analysis of the content item, one or more content categories indicating subject matter to which the content item relates, and/or an author or source of the content item.

Content and/or characteristics of content within a repository of media or multimedia within the data stores 118 may be annotated. Examples of content may include text, images, audio, video, or the like, which may be processed or stored in memory. The term “annotation,” as used herein, refers to descriptive or contextual content related to a content item, for example, collected from (or transmitted to) an individual, such as a user, and stored in association with the individual or the content item. Annotations may include various fields of descriptive content, such as a rating of a document, circumstances or context pertaining to the receipt of a document, a list of keywords identifying topics of a document, etc.

In some embodiments, as an individual interacts with a software application or a device such as a mobile device, descriptive content such as, for example, a date and/or time, may be identified and stored in the data stores 118 such that the descriptive content is stored in association with content. Descriptive content may also be stored along with contextual content. For example, how content such as a content item came to be identified (e.g., it was contained in a particular web page) may be stored in the data stores 118 as contextual content associated with the content. Contextual content, therefore, may identify circumstances surrounding receipt of content (e.g., date or time a content item was received or consumed and/or a source of the content item) and may be associated with descriptive content in the data stores 118. Contextual content, may, for example, be used to subsequently search for associated descriptive content. Accordingly, this additional contextual content and/or descriptive content may enable personalization to be performed based upon the information that is most likely to be relevant.

In addition, the data stores 118 may include account information (e.g., data) for a plurality of user accounts. Therefore, account information pertaining to user accounts may be retained in one or more memories that are coupled to the server 102.

The account information retained in the data stores 118 may include financial information such as credit card information, enabling goods or services provided in association with the account to be purchased. In addition, the account information may include information pertaining to goods or services available to the user via the user account or used by the user. More particularly, the account information may indicate an amount and/or quality of the goods or services available to the user or used by the user. In addition, the account information may indicate a cost associated with the amount and/or quality of goods or services available to the user or used by the user.

The account information may also include or be linked to additional information pertaining to the user. For example, the server(s) 102 may have access to additional user information, which may be retained in one or more user logs stored in the data stores 118. This user information or a portion thereof may be referred to as a user profile. More particularly, the user profile may include public information that is available in a public profile and/or private information. Furthermore, the user profile may include information that has been submitted by the user and/or information that has been deduced or automatically collected by the system (e.g., based upon user action(s)). In accordance with various embodiments, as an individual consumes content provided via a web site or via a device such as a mobile device, the user profile may be updated.

A profile builder may initiate generation of a profile, such as for users of an application, including a search engine or messaging application, for example. A profile builder may initiate generation of a user profile for use, for example, by a user, as well as by an entity that may have provided the application. For example, a profile builder may enhance relevance determinations and thereby assist in indexing, searching or ranking search results, as well as assist in the identification of further content to be provided via various media. Therefore, a provider such as a search engine provider may employ a profile builder.

A variety of mechanisms may be implemented to generate and/or update a profile including, but not limited to, collecting or mining navigation history, stored documents, tags, or annotations, to provide a few examples. In addition, the profile may be updated with information gathered as a result of the use of a device such as a mobile device. A profile builder may store a generated or updated profile.

The user information retained in the user logs 118 may include personal information such as demographic information and/or geographic information. Examples of demographic information include age and gender. Examples of geographic information include residence address, work address, and/or zip code.

Each time an individual performs online activities such as clicking on a content item (e.g., an advertisement or media item), purchasing goods or services, sending messages, retrieving messages, accessing a media item, posting information or content, or annotating content, information regarding such activity or activities may be retained as user data in the user logs 118. For instance, the user data that is retained in the user logs 118 may indicate the identity of web sites visited, identity of ads or content items that have been selected (e.g., clicked on) via the web site, and/or a timestamp indicating a date and/or time that the individual viewed or accessed the content item. Moreover, where the online publisher supports a search engine (e.g., via the server 102 or a separate search server), information associated with a search query, such as search term(s) of the search query, information indicating characteristics of search results that have been selected (e.g., clicked on) by the individual, and/or associated timestamp may also be retained in the user logs 118. Thus, the information may indicate whether the individual clicked on or viewed a content item and, if so, the number of clicks or views within a particular time period. An individual may be identified in the user logs 118 by a user ID (e.g., user account ID), email address, DNA, fingerprint, information in a user cookie, etc.

Each user profile may be associated with an individual and/or device, which may be identified by a device identifier such as an Internet Protocol (IP) address. In some implementations, the user profile or separate device profile may store further information associated with the device identifier, such as information indicating a device type. More particularly, the device type may include or otherwise indicate a category of device (e.g., mobile device), a brand of the device, and/or a model of the device. Although user profiles are described with reference to data store(s) 118 coupled to the server(s) 102, such a user profile or portion thereof may also be stored, maintained, and/or updated locally at the mobile device 106.

Based upon the information recorded in user profiles, it is possible to identify characteristics of items (e.g., content) that may be of interest to individuals (or a similarly situated group of individuals). For example, through the use of user profiles, a web site such as a search engine provider may retrieve annotations, tags, stored pages, navigation history, or the like, which may be useful for making relevance determinations of search results or content.

### EXAMPLE EMBODIMENTS

A mobile device is typically configured with an identifier. For example, the identifier associated with the mobile device may include an IP address. The identifier may be statically or dynamically configured at the mobile device.

When a user turns on or otherwise accesses a mobile device, an identity of the user of the mobile device may be ascertained via a variety of mechanisms. In some embodiments, an identity of the user (e.g., owner) of the device may be statically configured. Thus, the device may be keyed to an owner or multiple owners. In other embodiments, the device may automatically determine the identity of the user of the device. For instance, a user of the device may be identified by DNA, a retina scan, and/or finger print. In yet other embodiments, the user may submit an identifier (e.g., username or email address) and/or information for authenticating the user (e.g., password). Unfortunately, information commonly used to authenticate mobile devices such as a device identifier, user name, and password may easily be emulated by a computer.

In accordance with various embodiments, the mobile device may be configured with information indicating a device type of the mobile device. As described above, the device type may include a category of mobile devices, a brand of mobile device, and/or a model of the mobile device. Information indicating the device type of the mobile device may be stored in a memory of the mobile device.

The mobile device may initiate communication with a mobile infrastructure of a network to gain access to the network. However, before the mobile device can gain access to the network, an authentication process is performed. Various example methods of authenticating mobile devices will be described in further detail below.

Authentication Process

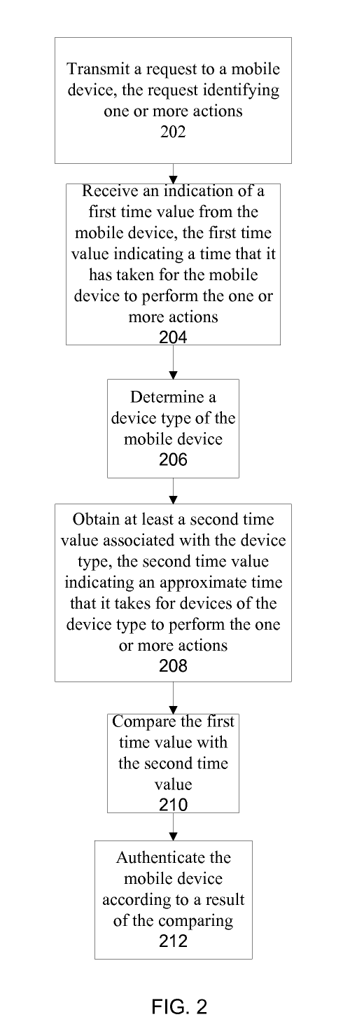

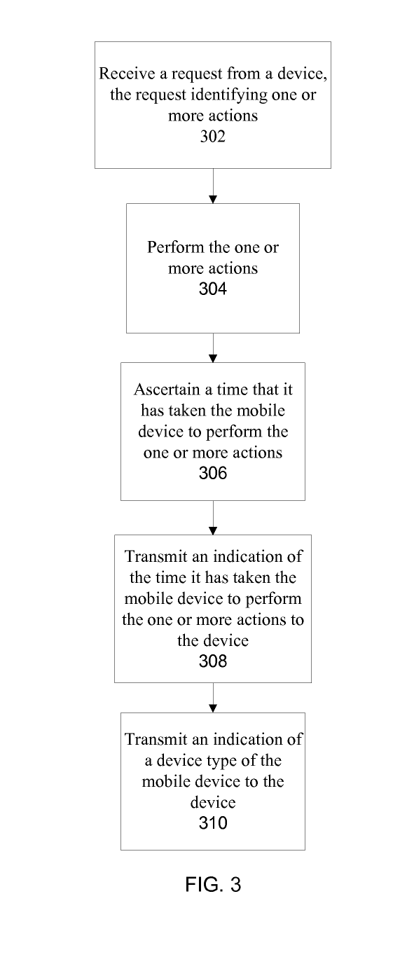

The disclosed embodiments may be implemented at a network and/or a mobile device. More particularly, an example method performed at a mobile infrastructure of the network will be described below with reference to FIG. 2, while an example method performed at the mobile device will be described below with reference to FIG. 3.

FIG. 2 is a process flow diagram illustrating an example method of authenticating a mobile device by a mobile infrastructure of a network according to various embodiments. The method may be performed by one or more devices within the network. For example, the method may be performed by one or more servers.

As shown at 202, a request may be transmitted to a mobile device, where the request identifies one or more actions. More particularly, the request may instruct the mobile device to perform the actions that are identified in the request. Alternatively, the request may simply serve as a request to receive the time that it takes for the mobile device to perform the actions. The actions may be selected from a plurality of actions that the mobile device is configured to perform. For example, the actions may be selected via a random function. In addition, the request may include one or more parameter values corresponding to input parameters associated with at least one of the actions. For example, the parameter values may be generated via a random number generator.

The actions may correspond to one or more performance benchmarks. Such performance benchmarks may include, but are not limited to, a computation, a graphics operation, and/or a memory operation. Therefore, each of the performance benchmarks may stress different properties of the hardware.

In response to the request, an indication of a first time value may be received at 204 from the mobile device, where the first time value indicates a time that it has taken for the mobile device to perform the actions. More particularly, a message indicating the first time value may be received. For example, the message may include a specific number of milliseconds. As another example, the message may include a start time and a stop time, where the start time indicates a time at which the mobile device initiated the actions and the stop time indicates a time at which the mobile device completed the actions.

In addition, a device type of the mobile device may be determined at 206. In some embodiments, a message indicating the device type of the mobile device may be received from the mobile device. The message indicating the device type of the mobile device may be the same message as that received at 204. Alternatively, the message may be a separate message from that received at 204. For example, a query indicating a request for the device type of the mobile device may be transmitted (either prior to or subsequent to the request transmitted at 202), and a message indicating the device type of the mobile device may be received in response to the query that has been transmitted to the mobile device.

In some embodiments, the indication of the device type may include a category of device, brand, and/or model. In other embodiments, the indication of the device type may merely include an identifier (e.g., IP address) of the mobile device, enabling the device type of the mobile device associated with the identifier to be determined by performing a lookup for the identifier.

In accordance with various embodiments, the device type may be identified based upon a device identifier. For example, a look up for the device identifier may be performed. If the device type cannot be ascertained via the lookup, the device may transmit a query indicating a request for the device type.

At least a second time value (or range of values) associated with the device type may be obtained at 208, where the second time value (or range of values) indicates an approximate expected time value (or expected range of values) that it generally takes for devices of the device type to perform the actions. For example, an expected range of values may be represented by a specific range or, alternatively, an amount or a percentage that the first time value can deviate from the second time value. More particularly, a lookup for the device type in a data store may be performed such that information associated with the device type is identified. One or more time values indicating expected completion times for the actions may then be retrieved from the information. Where the actions include two or more actions, the second time value (or range of values) may be a sum of the expected completion times (or ranges) for each of the separate actions.

The second time value (or range of values) may be compared with the first time value at 210, and the mobile device may be authenticated according to a result of the comparison at 212. More particularly, if the first time value falls within the expected range of values for the actions for the device type, the mobile device may be successfully authenticated. Alternatively, if the first time value does not fall within the expected range of values for the actions, the mobile device will not be successfully authenticated. In some embodiments, a likelihood that the actions have actually been executed by the mobile device (rather than spoofed via a computer) may be computed based, at least in part, upon the first time value and the second time value (or range of values).

In some embodiments, the expected range of values for the action(s) may be specified by a specific range of values. In other embodiments, the expected range of values may be specified by a particular second time value (e.g., average or mean value) and an acceptable error amount. The acceptable error amount may be a specific time value such as 0.1 mm, where the expected range of values is equal to a range from (second time value−error amount) to (second time value+error amount). In yet other embodiments, the acceptable error amount may be a particular percentage, where the time that it takes the device to perform the actions falls within the expected range if the difference between the second time value and the first time value is less than the particular percentage of the second time value. The acceptable error amount that is configured may be applicable to all device types, or may vary with the corresponding device types.

If the mobile device is successfully authenticated, the mobile device may access a network such as that associated with a web site. For example, the mobile device may access electronic mail via the network. As another example, the mobile device may access files, which may include deleting files, adding new files, or modifying existing files.

FIG. 3 is a process flow diagram illustrating an example method of communicating by a mobile device with a mobile infrastructure of a network to support authentication of the mobile device in accordance with various embodiments. A mobile device may receive a request from a device at 302, where the request identifies one or more actions. More particularly, the request may instruct the mobile device to perform the actions that are identified in the request. Alternatively, the request may simply serve as a request to receive the time that it takes for the mobile device to perform the actions. The actions specified in the request may be a subset of plurality of actions that the mobile device is configured to perform. In addition, the request may include one or more parameter values associated with corresponding input parameters of at least one of the actions.

The actions may correspond to one or more performance benchmarks. Such performance benchmarks may include, but are not limited to, a computation, a graphics operation, and/or a memory operation. For example, the actions may Include computing a value of pi to 50 decimal points, copying 1 megabyte of memory from one location to another location, reading 37 kilobytes of data from flash memory and writing it back to the flash memory, or drawing 1000 circles 100 pixels in size.

The mobile device may perform the actions at 304. In some embodiments, the actions may be performed dynamically in response to the request. In other embodiments, the mobile device may determine whether it has previously performed the actions (e.g., prior to receiving the request). For example, the mobile device may perform a lookup for a time that it has taken for the mobile device to perform the actions. If the mobile device determines that it has not performed the actions previously, the mobile device may perform the actions.

The mobile device may ascertain a time that it has taken the mobile device to perform the actions at 306. In some embodiments, the mobile device may set a timer when the mobile device begins performing the actions and stop the timer when the mobile device has completed performing the actions. The mobile device may store the time it takes to perform the actions, enabling the time to be retrieved at a later time. In other embodiments, the mobile device may perform a lookup for the actions to retrieve the time it has taken to perform the actions, and will use a timer to determine the time it takes to perform the actions if the time has not previously been stored (e.g., where the actions are performed after receipt of the request).

The mobile device may transmit an indication of the time it has taken to perform the actions at 308 to the device. More particularly, the mobile device may transmit a message indicating the time it has taken to perform the actions. For example, the message may include a specific number of milliseconds. As another example, the message may include a start time and a stop time, where the start time indicates a time at which the mobile device initiated the actions and the stop time indicates a time at which the mobile device completed the actions.

In addition, the mobile device may transmit an indication of a device type of the mobile device to the device at 310. More particularly, the indication of the device type may include an identifier (e.g., IP address) of the mobile device, enabling the device to lookup the device type of the mobile device type. Alternatively, the indication of the device type may include a category of device, brand, and/or model. The indication of the device type may be transmitted in the message described at 308 or via a separate message. In some embodiments, the mobile device may transmit the indication of the device type in response to a query indicating a request for a device type of the mobile device, where the query has been received from the device. This query may be received prior to or subsequent to the request described at 302.

The mobile device may be authenticated by the device based, at least in part, upon the time it has taken to complete the actions and the device type, as described above with reference to FIG. 2. More particularly, the device may compare the time it has taken for the mobile device to complete the actions with at least one expected time (or expected range of time) indicating an approximate time that it should generally take for mobile devices of the device type to complete the actions. If the time it has taken for the mobile device to complete the actions falls within the expected time (or range of time), the mobile device is successfully authenticated. The mobile device may gain access to a network upon successful authentication.

Generally, mobile devices of different device types will perform the same action in a substantially different period of time from one another. For example, the time that it takes a mobile device of one device type to perform an action may vary from the time that it takes another mobile device of another device type to perform the same action by a factor of 2. As a result, the disclosed embodiments provide an accurate means for authenticating mobile devices.

The disclosed embodiments provide a mechanism for authenticating a mobile device that is difficult for other devices to emulate. In fact, the time that it takes a mobile device to perform an action may vary from the time that it takes a computer to perform the same action by a factor of 15. Therefore, it would be particularly difficult for a computer to accurately ascertain the time that it would take a mobile device to perform a particular action.

Network

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

Content Distribution Network

A distributed system may include a content distribution network. A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

Peer-to-Peer Network

A peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.”

Wireless Network

A wireless network may couple client devices with a network. A wireless network may employ stand-alone ad-hoc networks, mesh networks, Wireless LAN (WLAN) networks, cellular networks, or the like.

A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Internet Protocol

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6.

The Internet refers to a decentralized global network of networks. The Internet includes LANs, WANs, wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

Social Network

The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be created according to user profiles of individuals, for example, in which a subgroup member may belong to multiple subgroups. An individual may also have multiple “1: few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so called ‘virtual persons.’ An individual's social network may be represented in a variety of forms, such as visually, electronically or functionally. For example, a “social graph” or “socio-gram” may represent an entity in a social network as a node and a relationship as an edge or a link.

Multi-Modal Communication (MMC)

Individuals within one or more social networks may interact or communicate with other members of a social network via a variety of devices. Multi-modal communication technologies refers to a set of technologies that permit interoperable communication across multiple devices or platforms, such as cellphones, smart phones, tablet computing devices, personal computers, televisions, SMS/MMS, email, instant messenger clients, forums, social networking sites (such as Facebook, Twitter, or Google), or the like.

Network Architecture

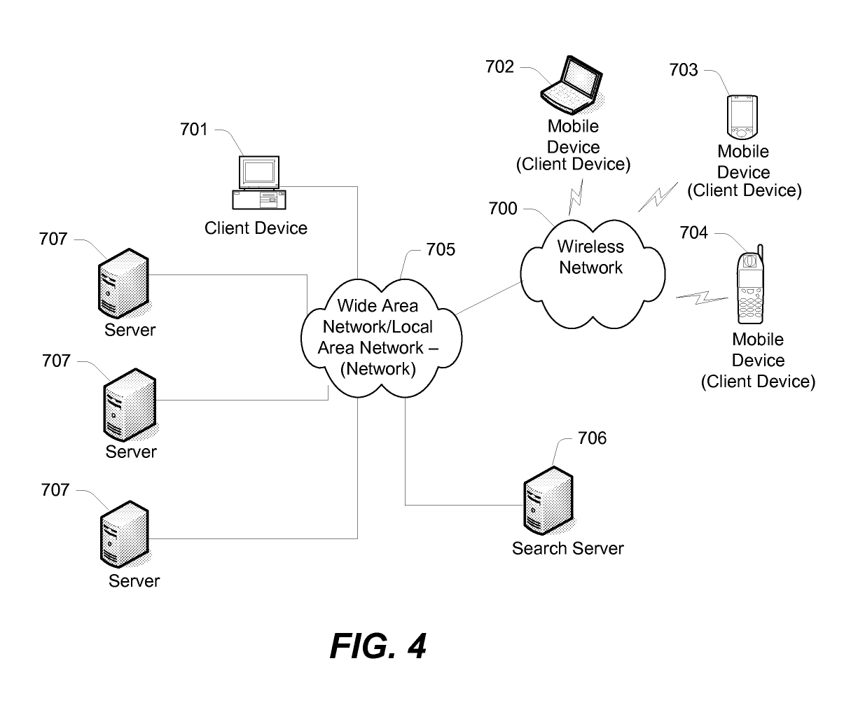

The disclosed embodiments may be implemented in any of a wide variety of computing contexts. FIG. 4 is a schematic diagram illustrating an example embodiment of a network. Other embodiments that may vary, for example, in terms of arrangement or in terms of type of components, are also intended to be included within claimed subject matter. Implementations are contemplated in which users interact with a diverse network environment. As shown, FIG. 4, for example, includes a variety of networks, such as a LAN/WAN 705 and wireless network 700, a variety of devices, such as client devices 701-704, and a variety of servers such as content server(s) 707 and search server 706. The servers may also include an ad server (not shown). As shown in this example, the client devices 701-704 may include one or more mobile devices 702, 703, 704. Client device(s) 701-704 may be implemented, for example, via any type of computer (e.g., desktop, laptop, tablet, etc.), media computing platforms (e.g., cable and satellite set top boxes), handheld computing devices (e.g., PDAs), cell phones, or any other type of computing or communication platform.

The disclosed embodiments may be implemented in some centralized manner. This is represented in FIG. 4 by server(s) 707, which may correspond to multiple distributed devices and data store(s). The server(s) 707 and/or corresponding data store(s) may store user account data, user information, and/or content.

Server

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Content Server

A content server may comprise a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor-type or programmable consumer electronics, etc.

Crawler

A crawler may be operable to communicate with a variety of content servers, typically via a network. In some embodiments, a crawler starts with a list of URLs to visit. The list may be called a seed list. As the crawler visits the URLs in the seed list, it identifies all the hyperlinks in the page and adds them to a list of URLs to visit, called the crawl frontier. URLs from the crawler frontier are recursively visited according to a set of policies. A crawler typically retrieves files by generating a copy for storage, such as local cache storage. A cache refers to a persistent storage device. A crawler may likewise follow links, such as HTTP hyperlinks, in the retrieved file to additional files and may retrieve those files by generating copy for storage, and so forth. A crawler may therefore retrieve files from a plurality of content servers as it “crawls” across a network.

Indexing

An indexer may be operable to generate an index of content, including associated contextual content, such as for one or more databases, which may be searched to locate content, including contextual content. An index may include index entries, wherein an index entry may be assigned a value referred to as a weight. An index entry may include a portion of the database. In some embodiments, an indexer may use an inverted index that stores a mapping from content to its locations in a database file, or in a document or a set of documents. A record level inverted index contains a list of references to documents for each word. A word level inverted index additionally contains the positions of each word within a document. A weight for an index entry may be assigned. For example, a weight, in one example embodiment may be assigned substantially in accordance with a difference between the number of records indexed without the index entry and the number of records indexed with the index entry.

Client Device

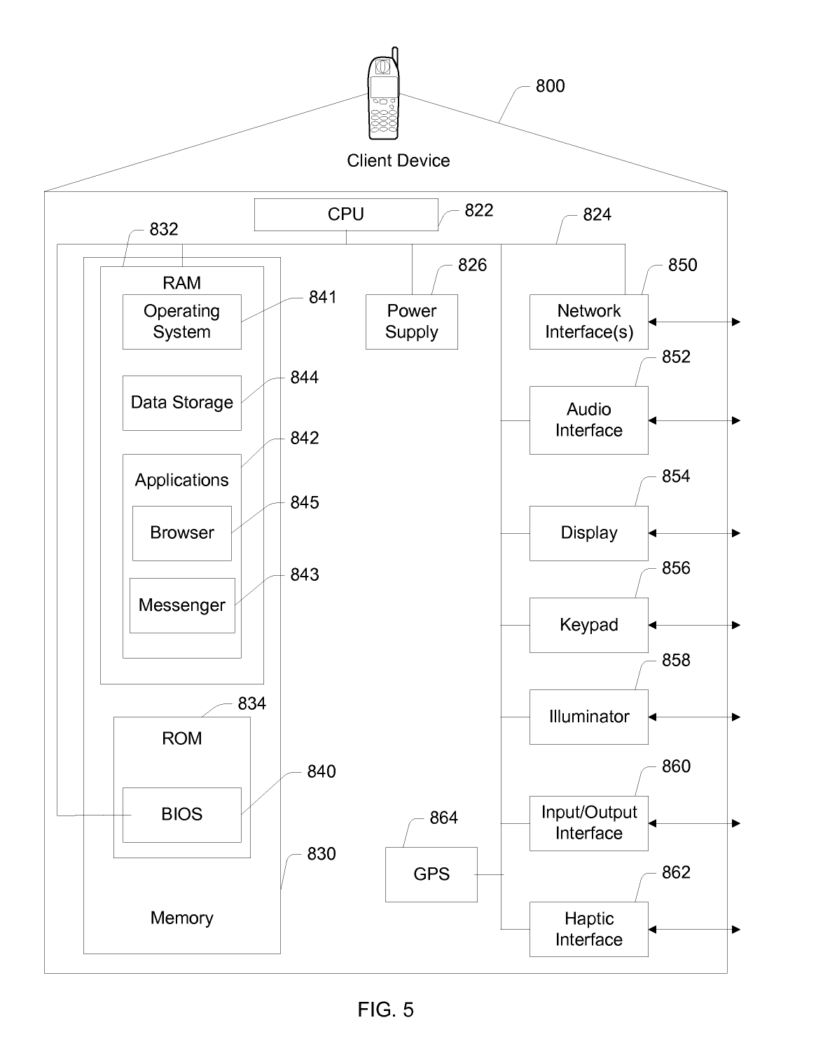

FIG. 5 is a schematic diagram illustrating an example embodiment of a client device in which various embodiments may be implemented. A client device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like. A portable device may also be referred to as a mobile device or handheld device.

As shown in this example, a client device 800 may include one or more central processing units (CPUs) 822, which may be coupled via connection 824 to a power supply 826 and a memory 830. The memory 830 may include random access memory (RAM) 832 and read only memory (ROM) 834. The ROM 834 may include a basic input/output system (BIOS) 840.

The RAM 832 may include an operating system 841. More particularly, a client device may include or may execute a variety of operating systems, including a personal computer operating system, such as a Windows, iOS or Linux, or a mobile operating system, such as iOS, Android, or Windows Mobile, or the like. The client device 800 may also include or may execute a variety of possible applications 842 (shown in RAM 832), such as a client software application such as messenger 843, enabling communication with other devices, such as communicating one or more messages, such as via email, short message service (SMS), or multimedia message service (MMS), including via a network, such as a social network, including, for example, Facebook, LinkedIn, Twitter, Flickr, or Google, to provide only a few possible examples. The client device 800 may also include or execute an application to communicate content, such as, for example, textual content, multimedia content, or the like, which may be stored in data storage 844. A client device may also include or execute an application such as a browser 845 to perform a variety of possible tasks, such as browsing, searching, playing various forms of content, including locally stored or streamed video, or games (such as fantasy sports leagues).

The client device 800 may send or receive signals via one or more interface(s). As shown in this example, the client device 800 may include one or more network interfaces 850. The client device 800 may include an audio interface 852. In addition, the client device 800 may include a display 854 and an illuminator 858. The client device 800 may further include an Input/Output interface 860, as well as a Haptic Interface 862 supporting tactile feedback technology.

The client device 800 may transmit and detect patterns, images, or signals such as infra-red signals via the interface(s). For example, the client device 800 may transmit an infra-red blink pattern, as well as detect an infra-red blink pattern, as described herein.

The client device 800 may vary in terms of capabilities or features. Claimed subject matter is intended to cover a wide range of potential variations. For example, a cell phone may include a keypad such 856 such as a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) 864 or other location identifying type capability, or a display with a high degree of functionality, such as a touch-sensitive color 2D or 3D display, for example. The foregoing is provided to illustrate that claimed subject matter is intended to include a wide range of possible features or capabilities.

According to various embodiments, input may be obtained using a wide variety of techniques. For example, input for downloading or launching an application may be obtained via a graphical user interface from a user's interaction with a local application such as a mobile application on a mobile device, web site or web-based application or service and may be accomplished using any of a variety of well-known mechanisms for obtaining information from a user. However, it should be understood that such methods of obtaining input from a user are merely examples and that input may be obtained in many other ways.

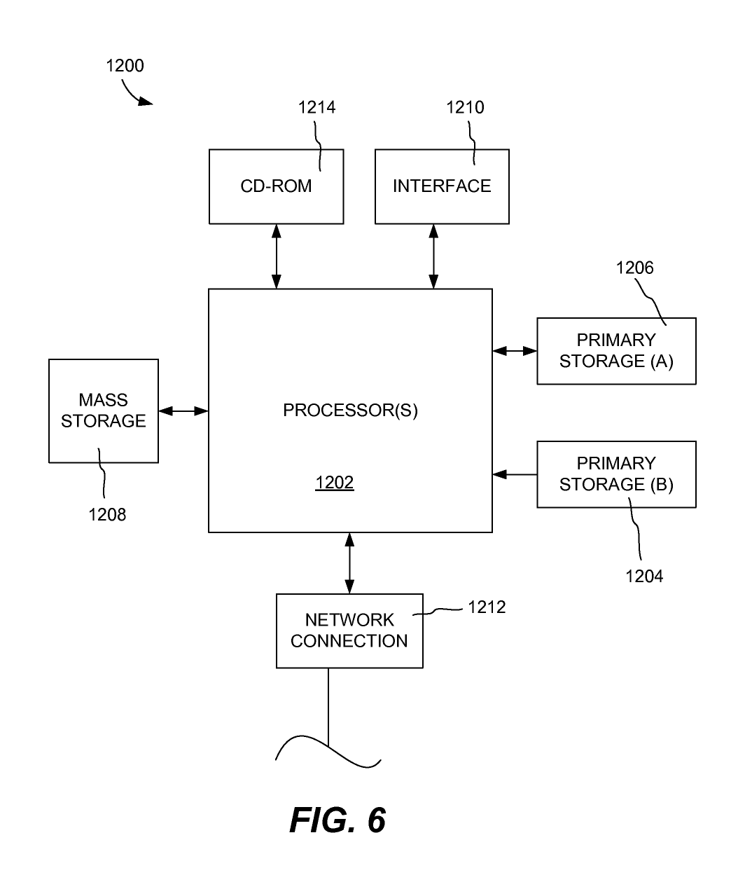

FIG. 6 illustrates a typical computer system that, when appropriately configured or designed, can serve as a system via which various embodiments may be implemented. The computer system 1200 includes any number of CPUs 1202 that are coupled to storage devices including primary storage 1206 (typically a RAM), primary storage 1204 (typically a ROM). CPU 1202 may be of various types including microcontrollers and microprocessors such as programmable devices (e.g., CPLDs and FPGAs) and unprogrammable devices such as gate array ASICs or general purpose microprocessors. As is well known in the art, primary storage 1204 acts to transfer data and instructions uni-directionally to the CPU and primary storage 1206 is used typically to transfer data and instructions in a bi-directional manner. Both of these primary storage devices may include any suitable computer-readable media such as those described above. A mass storage device 1208 is also coupled bi-directionally to CPU 1202 and provides additional data storage capacity and may include any of the computer-readable media described above. Mass storage device 1208 may be used to store programs, data and the like and is typically a secondary storage medium such as a hard disk. It will be appreciated that the information retained within the mass storage device 1208, may, in appropriate cases, be incorporated in standard fashion as part of primary storage 1206 as virtual memory. A specific mass storage device such as a CD-ROM 1214 may also pass data uni-directionally to the CPU.

CPU 1202 may also be coupled to an interface 1210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1202 optionally may be coupled to an external device such as a database or a computer or telecommunications network using an external connection as shown generally at 1212. With such a connection, it is contemplated that the CPU might receive information from the network, or might output information to the network in the course of performing the method steps described herein.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store instructions for performing the disclosed methods, graphical user interfaces to be displayed in association with the disclosed methods, etc.

Because such information and program instructions may be employed to implement the systems/methods described herein, the disclosed embodiments relate to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as optical disks; and hardware devices that are specially configured to store and perform program instructions, such as ROM and RAM. Examples of program instructions include both machine code, such as produced by a compiler, and files containing higher level code that may be executed by the computer using an interpreter.

Computer program instructions with which various embodiments are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques may be implemented in any suitable combination of software and/or hardware system, such as a web-based server or desktop computer system. Moreover, a system implementing various embodiments may be a portable device, such as a laptop or cell phone. An apparatus and/or web browser may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the disclosed method steps.

Although the foregoing embodiments have been described in some detail for purposes of clarity of understanding, it will be apparent that certain changes and modifications may be practiced within the scope of the appended claims. Therefore, the present embodiments are to be considered as illustrative and not restrictive, and are not to be limited to the details given herein, but may be modified within the scope and equivalents of the appended claims.

What is claimed is:

1. A method, comprising:
transmitting a request to a mobile device, the request identifying one or more actions;
receiving an indication of a first time value from the mobile device, the first time value indicating a time that it has taken for the mobile device to perform the one or more actions;
determining a device type of the mobile device;
obtaining at least a second time value associated with the device type, the second time value indicating an approximate time that it takes for devices of the device type to perform the one or more actions;
comparing the first time value with the second time value; and
authenticating the mobile device according to a result of the comparing.

2. The method as recited in claim 1, wherein the request instructs the mobile device to perform the one or more actions.

3. The method as recited in claim 1, wherein the request comprises one or more values associated with one or more parameters associated with the one or more actions.

4. The method as recited in claim 1, further comprising:
selecting the one or more actions from a plurality of actions.

5. The method as recited in claim 1, wherein determining a device type of the mobile device comprises:
transmitting a query to the mobile device, the query indicating a request for a device type of the mobile device; and
receiving an indication of the device type from the mobile device.

6. The method as recited in claim 1, wherein the one or more actions comprise at least one of a computation, a graphics operation, or a memory operation.

7. The method as recited in claim 1, wherein obtaining a second time value associated with the device type comprises:
performing a look up for the device type in a data store such that information associated with the device type is identified; and
retrieving one or more time values associated with the one or more actions from the information identified in the data store.

8. An apparatus, comprising:
a processor; and
a memory, at least one of the processor or the memory being configured for:
receiving a request at a mobile device from a device, the request identifying one or more actions;
performing by the mobile device the one or more actions;
ascertaining by the mobile device a time that it has taken the mobile device to perform the one or more actions;
transmitting an indication of the time by the mobile device to the device; and
transmitting an indication of a device type of the mobile device by the mobile device to the device.

9. The apparatus as recited in claim 8, wherein the mobile device is authenticated based, at least in part, upon the time and the device type.

10. The apparatus as recited in claim 8, at least one of the processor or the memory being further configured for performing operations, comprising:
receiving a query, the query indicating a request for a device type of the mobile device;
wherein transmitting an indication of the device type of the mobile device is performed in response to receiving the query.

11. The apparatus as recited in claim 8, wherein the request comprises one or more values associated with one or more input parameters of at least one of the actions.

12. The apparatus as recited in claim 8, wherein the request identifies the one or more actions from a plurality of actions that the mobile device is configured to perform.

13. The apparatus as recited in claim 8, wherein the one or more actions comprise at least one of a computation, a graphics operation, or a memory operation.

14. The apparatus as recited in claim 8, wherein ascertaining by the mobile device a time that it has taken the mobile device to perform the one or more actions comprises:
setting a timer.

15. A non-transitory computer-readable storage medium, comprising:
instructions for performing one or more actions by a mobile device in response to a request received from another device;
instructions for ascertaining a time that it has taken the mobile device to perform the one or more actions;
instructions for transmitting, by the mobile device to the device, an indication of a device type of the mobile device; and
instructions for transmitting, by the mobile device to the device, an indication of the time that it has taken the mobile device to perform the one or more actions.

16. The non-transitory computer-readable storage medium as recited in claim 15, wherein the mobile device is authenticated based, at least in part, upon the time and the device type.

17. The non-transitory computer-readable storage medium as recited in claim 15, wherein the one or more actions comprise at least one of a computation, a graphics operation, or a memory operation.

18. The non-transitory computer-readable storage medium as recited in claim 15, wherein the device type comprises at least one of a brand or a model.

19. The non-transitory computer-readable storage medium as recited in claim 15, wherein the request comprises one or more values associated with one or more parameters, and wherein the instructions for performing the one or more actions include the one or more parameters.

20. The non-transitory computer-readable storage medium as recited in claim 18, wherein the request identifies the one or more actions from a plurality of actions that the mobile device is configured to perform.
